(19) United States
(12) Patent Application Publication
(10) Pub. No.: US 2005/0096795 A1
(43) Pub. Date: May 5, 2005

(54) Wireless fluid inventory management system

(76) Inventors: Kenneth J. Krieter, Edina, MN (US); Mark A. King, New Richmond, WI (US); D. Christian Koch, Maple Grove, MN (US); Thomas C. Neese, Plymouth, MN (US); Eugene G. Thury, St. Paul, MN (US); Michael J. Marshik, Circle Pines, MN (US); Steven R. Knop, Hutchinson, MN (US); David J. Lorden, Zimmerman, MN (US); Gregory W. Parkhurst, Brooklyn Park, MN (US)

Correspondence Address: Douglas B. Farrow;Graco Minnesota Inc., P.O. Box 1441, Minneapolis, MN, 55440-1441, US

(21) Appl. No.: 10/701,308

(22) Filed: Nov. 4, 2003

(51) Int. Cl. G05D 9/00

(52) U.S. Cl. 700/281

(57) ABSTRACT

The system is designed to provide PC based comprehensive fluid management for automotive lubrication that is easy to install, operate and troubleshoot. The system utilizes facility's current business PC and is comprised of PC software, wireless PC transceiver, linked wireless repeater, standard wireless repeater, wireless electronic meter, wireless tank level monitor and pulse charger all in quantities as required for a given service facility. The PC software communicates directly with the meters via wireless communication modules (e.g. PC transceiver and repeaters) to set desired operational defaults, to control security authorization (if desired), to receive all dispense transactions (tied to work order or repair order if desired) and to receive rechargeable battery levels.

### BACKGROUND ART

Various fluid dispensing systems have been provided over the years for use in various vehicle maintenance settings (dealers, fleets, etc.) While such systems have been generally effective, they often suffer from various deficiencies such as the need for extensive wiring and the failure to adequately control dispensing of fluids such that the resulting inventory shrinkage can approach 30%.

### DISCLOSURE OF THE INVENTION

It is therefore an object of this invention to provide a management system which is easy to install and use and which can be configured to provide the desired degree of security and ease of operator use.

The system is designed to provide PC based comprehensive fluid management for automotive lubrication that is easy to install, operate and troubleshoot. The system utilizes facility's current business PC and is comprised of PC software, wireless PC transceiver, linked wireless repeater, standard wireless repeater, wireless electronic meter, wireless tank level monitor and pulse charger all in quantities as required for a given service facility. The PC software communicates directly with the meters via wireless communication modules (i.e., PC transceiver and repeaters) to set desired operational defaults, to control security authorization (if desired), to receive all dispense transactions (tied to work order or repair order if desired) and to receive rechargeable battery levels.

The PC software also communicates directly with the tank level monitor via the same wireless communication modules to set operational defaults, to receive periodic tank level readings and to receive battery level readings. All operational and inventory data is time/date stamped and stored in the PC software database. The software inventory arranges the data for ease of viewing, and custom reports can be generated to facilitate operational and fluid inventory management. The software can be set to e-mail reports to oil distributors on a periodic basis to enhance the ability to manage fluid deliveries.

This results in:
greatly reduced system installation cost;
eliminates system complexity for ease of installation and troubleshooting;
runs behind the scenes with little or no operator intervention;
easily integrated into a customer's facility using existing business PC and replacing existing hose end dispense valve;
stores accurate, easy-to-access fluid inventory data; and
provides the oil distributor access to up to date fluid inventory levels for timely delivery planning.

The administrator establishes the operational settings for each tank level monitor in the system during the set-up process at the PC. These settings are communicated to the PC transceiver then via wireless RF link to each tank level monitor. The administrator defines the specifications for each tank which allows PC software to convert data to actual volumetric measurement (i.e., gallons, liters). This is used in conjunction with ultrasonic measurement to define actual tank levels. The administrator also sets the scheduled tank level readings for each tank level monitor. These settings can only be altered by the authorized system administrator in the set-up portion of the PC software.

This simplifies and secures desired operational settings for tank level monitor. It also permits tamper-proof micro-controlled calibration, volumetric specifications and scheduled tank readings. Settings allow user to manage battery life of monitor.

During the initialization process for each system module, the PC software wirelessly assigns a unique encrypted address. This module then knows its assigned address and receives and acts upon transmissions which include this address. Also all wireless transmissions from this module to the PC contain the address for proper signal source identification.

This on-site initialization method allows for uniform mass production of system modules, preventing the need to uniquely program each module. It also simplifies the design of the PC software, eliminating the need for the software to identify a large number of lengthy module addresses. Provide method of establishing unique RF wireless communication identity for each module in a fluid inventory control system, (i.e., meters, tank level monitors, repeaters, wall-busters, etc.)

For installation, the following steps need to take place. Create a rough drawing of the building layout where the system will be installed, or use a facility layout drawing if available. Identify on the drawing where the meters and tank monitors will be positioned. For example, Meter 1, Bay 1, and Tank Monitor 1, 5W30. Transfer this information onto individual tags and attach each to the individual meters and tank monitors. This allows the corresponding component to be correctly programmed with the software.

Program the meters and tank monitors using the description on the tags. Then install them using the facility layout drawing made earlier. Transfer each meter and tank monitor description from the system facility drawing to a tag and attach each tag to the corresponding meters and tank monitors. Install the batteries into the meters and tank monitors. Place the tagged meters and tank monitors near the transceiver and PC for programming. After the meter and tank level monitor information is entered at the PC (meter number, bay location etc.) the meters and tank monitors must be linked or programmed to their profile on the PC. To program the meters, the PC must be at the Meter Set-up screen. Similarly, to program the tank level monitors, the PC must be at the Tank Level Monitor Set-up screen.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a typical installation of the instant invention.

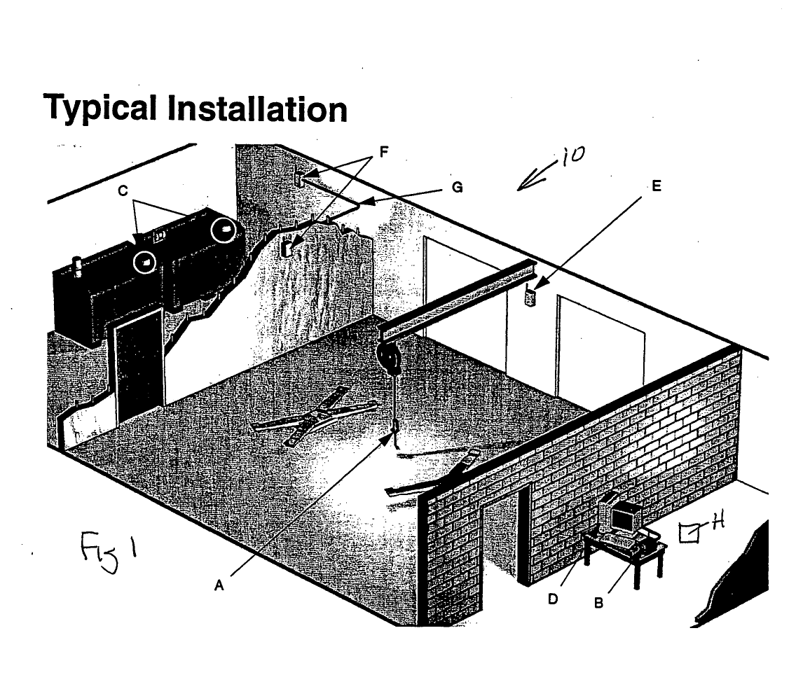

FIG. 2 is a flow chart showing the main event handler.

FIG. 3 is a flow chart showing the setup event handler.

FIG. 4 is a flow chart showing the connection event handler.

FIG. 5 is a flow chart showing the dispense event handler.

FIG. 6 is a flow chart showing the tank inventory event handler.

FIG. 7 is a flow chart showing the battery level event handler.

FIG. 8 is a flow chart showing the dispense history event handler.

### BEST MODE FOR CARRYING OUT THE INVENTION

The instant invention, generally designated 10, The system is designed to provide PC based comprehensive fluid management for automotive lubrication that is easy to install, operate and troubleshoot. The system utilizes facility's current business PC D and is comprised of PC software, wireless PC transceiver B, linked wireless repeaters F (connected by cable G), standard wireless repeater E, wireless electronic meter A, wireless tank level monitor C and pulse charger H all in quantities as required for a given service facility.

The PC software communicates directly with the meters A via wireless communication modules (e.g. PC transceiver B and repeaters E and F)) to set desired operational defaults, to control security authorization (if desired), to receive all dispense transactions (tied to work order or repair order if desired) and to receive rechargeable battery levels.

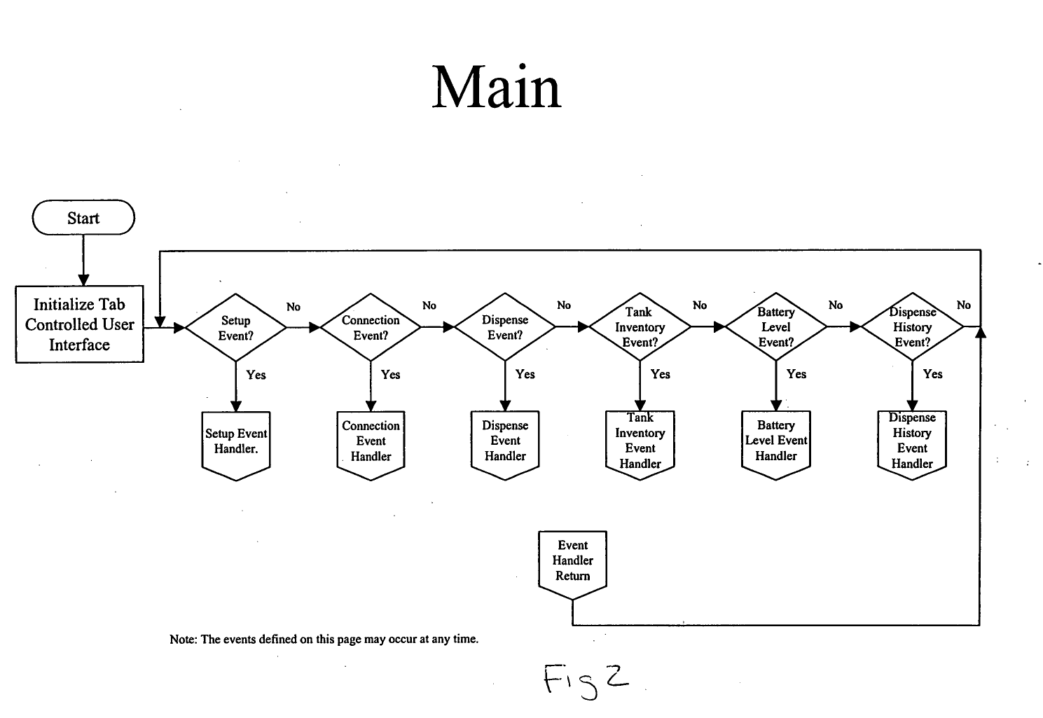

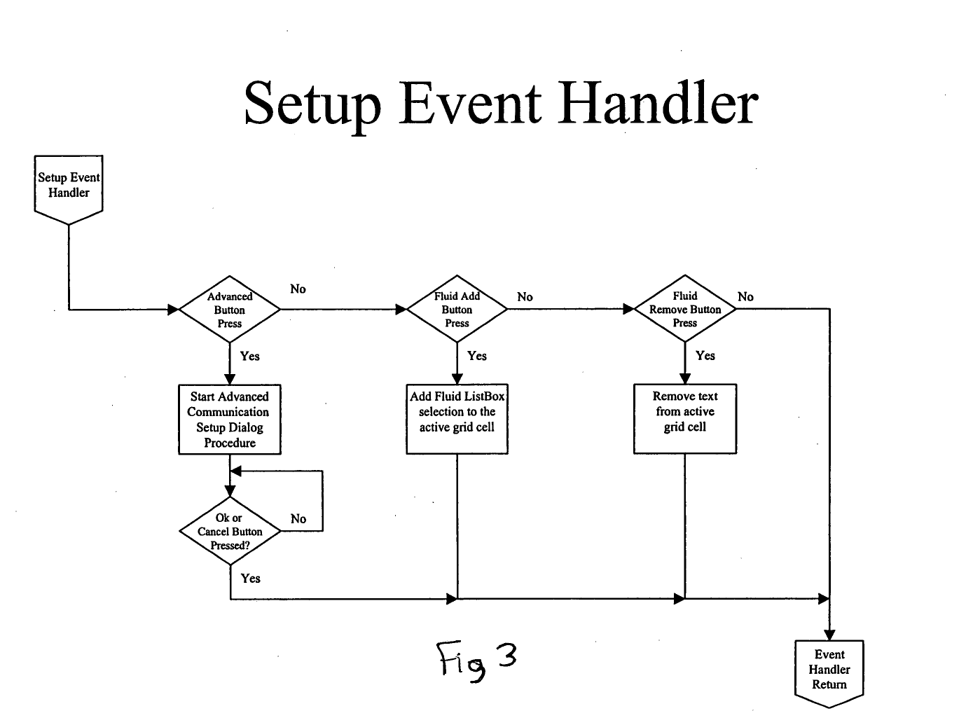

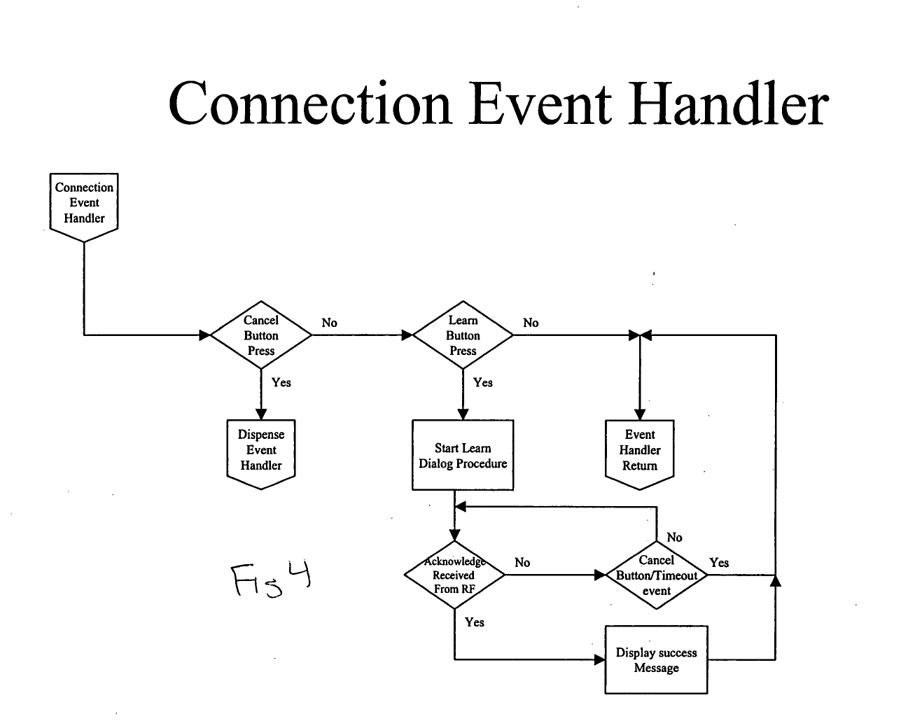

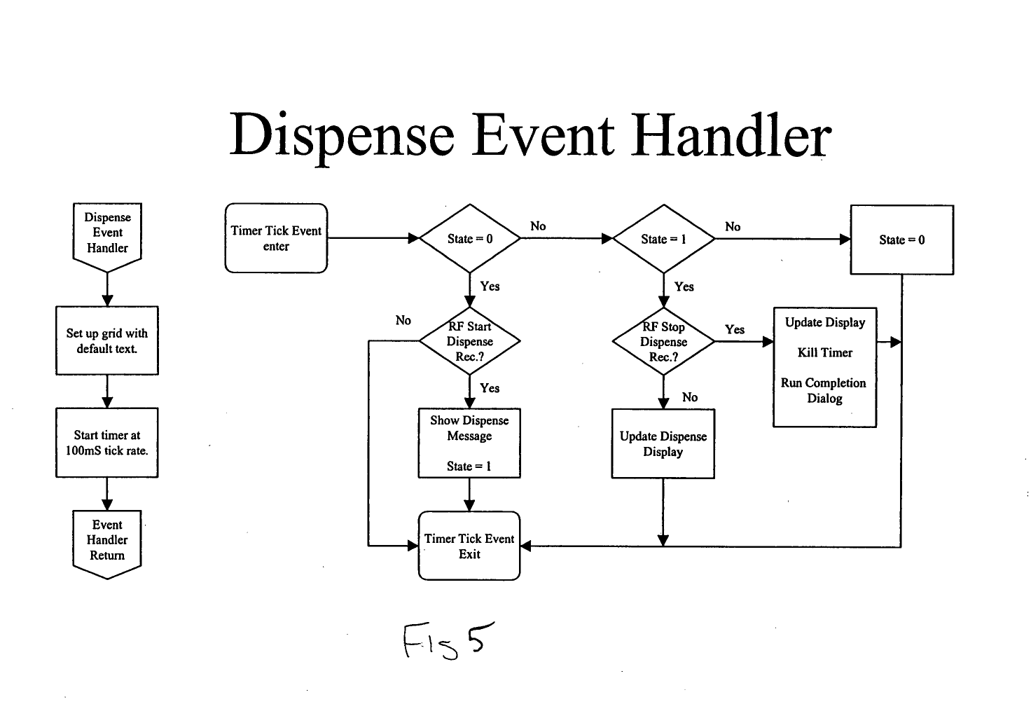

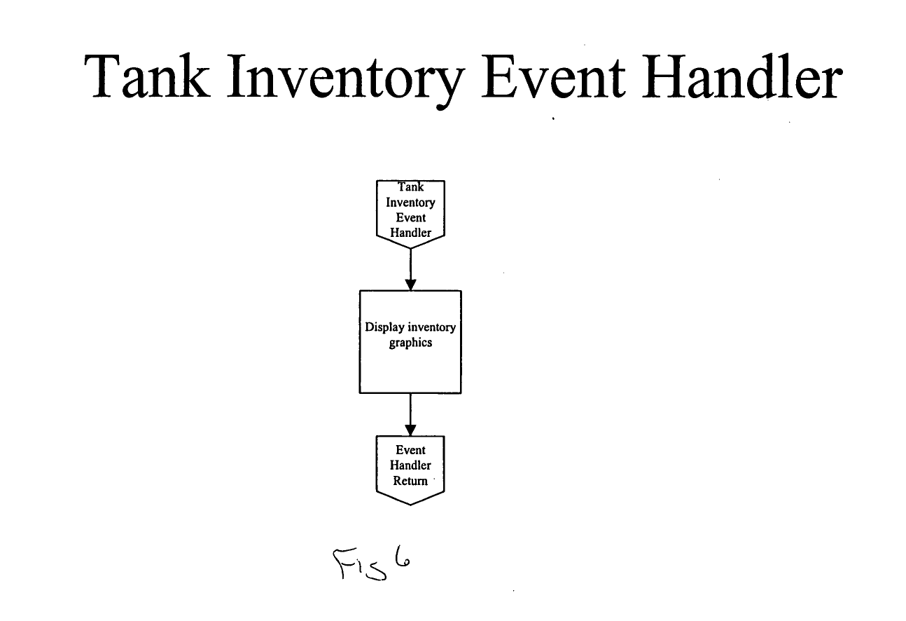

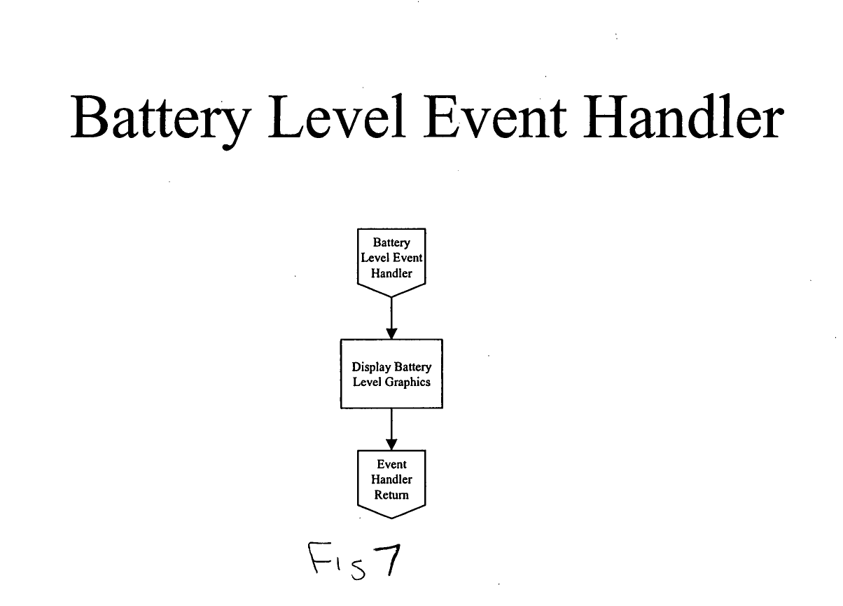

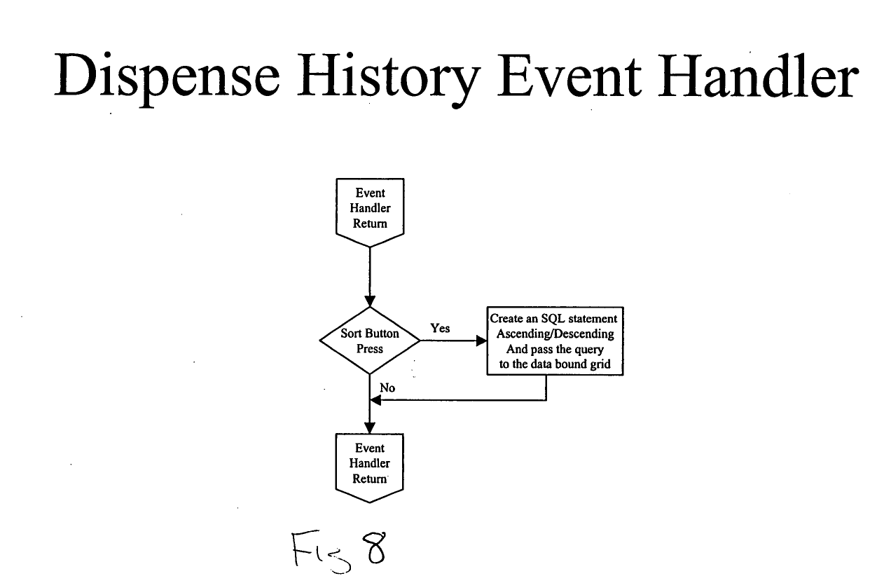

The PC software also communicates directly with the tank level monitor C via the same wireless communication modules to set operational defaults, to receive periodic tank level readings and to receive battery level readings. All operational and inventory data is time/date stamped and stored in the PC software database. The software inventory arranges the data for ease of viewing, and custom reports can be generated to facilitate operational and fluid inventory management. The software can be set to e-mail reports to oil distributors on a periodic basis to enhance the ability to manage fluid deliveries. Flow charts showing the main software routines are in FIGS. 2-8

The administrator establishes the operational settings for each tank level monitor C in the system during the set-up process at the PC. These settings are communicated to the PC transceiver then via wireless RF link to each tank level monitor C. The administrator defines the specifications for each tank which allows PC software to convert data to actual volumetric measurement (e.g. gallons, liters). This is used in conjunction with ultrasonic measurement to define actual tank levels. The administrator also sets the scheduled tank level readings for each tank level monitor C. These settings can only be altered by the authorized system administrator in the set-up portion of the PC software.

This simplifies and secures desired operational settings for tank level monitor C. It also permits tamper-proof micro-controlled calibration, volumetric specifications and scheduled tank readings. Settings allow user to manage battery life of monitor.

During the initialization process for each system module (meter A or tank level monitor C), the PC software wirelessly assigns a unique encrypted address. This module then knows its assigned address and receives and acts upon transmissions which include this address. Also all wireless transmissions from this module to the PC D contain the address for proper signal source identification.

This on-site initialization method allows for uniform mass production of system modules, preventing the need to uniquely program each module. It also simplifies the design of the PC software, eliminating the need for the software to identify a large number of lengthy module addresses. Provide method of establishing unique RF wireless communication identity for each module in a fluid inventory control system, (i.e., meters A, tank level monitors C, repeaters E and F, etc.)

It is contemplated that various changes and modifications may be made to the fluid inventory management system without departing from the spirit and scope of the invention as defined by the following claims.

1. A method for registering and communicating between a central control authorization point and a plurality of remote location devices comprising the steps of:
providing a said remote location device;
preparing said remote location device for registration;
registering said remote location device on said central control authorization point and transmitting an encrypted address unique to each said remote location device and storing said unique address thereon; and
utilizing said unique encrypted address for communication between said central control authorization point and said remote location device.

2. The method of claim 1 wherein said remote location device comprises a fluid meter.

3. The method of claim 1 wherein said remote location device comprises a tank level monitor.
